(19) United States
(12) Patent Application Publication
(10) Pub. No.: US 2019/0320077 A1
(43) Pub. Date: Oct. 17, 2019

(54) POP-UP STUDIO

(71) Applicant: Michael John Kirby, Santa Monica, CA (US)

(72) Inventor: Michael John Kirby, Santa Monica, CA (US)

(21) Appl. No.: 15/953,335

(22) Filed: Apr. 13, 2018

(51) Int. Cl. H04N 1/00; G03B 15/00; B31B 50/26

(52) U.S. Cl. CPC H04N 1/00541; H04N 2201/0084; B31B 50/26; G03B 15/00

(57) ABSTRACT

Provided are embodiments of portable devices that, when used with a digital camera device, e.g., mobile phone camera, can capture a high quality photograph of a printed photograph or a document, thereby reducing or eliminating reliance on expensive, bulky electrical equipment for post-processing or editing to correct lighting, reflection, and cropping. The device can include a box that can be made of cardboard; can be collapsed flat; can easily fit in a book bag, a brief case, or similar carrier; and is easy to ship. The device also could be fully assembled or molded of plastic, while still maintaining the function as a mobile studio.

### TECHNICAL FIELD

The subject matter described herein relates generally to the photography, scanning, or image-capture of printed photographs and documents. More particularly, it relates to portable devices to facilitate the photography, scanning, or image-capture of printed photographs and documents using digital camera devices including mobile phone cameras.

### BACKGROUND

Currently, popular means of capturing an image of a printed photograph or document generally include (1) holding by hand a mobile phone camera at an undefined distance from the printed photograph or document or (2) using a scanner to make a copy of the printed photograph or document. Hand-held attempts to photograph a printed photograph or document are prone to distortion (especially when the camera lens is not parallel with the object), glare (from multiple light sources), reflection (often of the mobile phone camera itself and/or the hand of the photographer), and imprecise framing. Access to a scanner is often limited, expensive, bulky, and restricted by electrical power location.

Photograph Editing Applications can be used to detect and to reduce glare in a taken digital photograph. But they suffer from the corruption of the image in the first place, and cannot achieve the higher quality of an image captured without lighting artifacts and image distortion.

Several applications exist to “scan” and then to crop photographs. Such applications, however, are prone to the reflection and distortion that result from a hand-held camera phone hovering above a glossy printed photograph.

A need therefore exists to develop portable devices to facilitate the photography, scanning, or image-capture of printed photographs and documents using digital camera devices, including mobile phone cameras, without the above mentioned and other disadvantages.

### SUMMARY

Provided herein are embodiments of portable devices that, when used with a digital camera device, e.g., mobile phone camera, can capture a high quality photograph of a printed photograph or a document, thereby reducing or eliminating reliance on expensive, bulky electrical equipment for post-processing or editing to correct lighting, reflection, and cropping. The device (which can be referred to herein as “the pop-up studio,” “Pop-Up Photo Studio” or “Pop-Up Document Library”) can include a box that can be made of cardboard; can be collapsed flat; can easily fit in a book bag, a brief case, or similar carrier; and is easy to ship. The device also could be fully assembled or molded of plastic, while still maintaining the function as a mobile studio. The interior surface of the box is of flat white color, to limit reflection. The exterior of the box includes an outline to guide placement of a digital camera device, e.g., mobile phone camera, on the surface of the box in line with a hole for the camera lens. It should be noted that alternate embodiments of the device can include guide lines and various colors, e.g. white surfaces or colored surfaces both on the inside or outside of the device.

It should be noted that when a digital camera device is described herein being used with the portable device of the disclosure, a person skilled in the art would understand that the digital camera device may be part of a mobile phone, a portable device, a wearable device, etc.

The pop-up studio can be produced for any digital camera device shooting a photograph of a printed photograph or document. In some embodiments, the pop-up studio can be optimized for a digital camera device shooting a 4″×6″ photograph. In some embodiments, the pop-up studio can be optimized for a digital camera device shooting a photograph of any size (3×5, 4×6, 5×7, 8×10, etc.).

In other embodiments, the pop-up studio may be optimized for a digital camera device shooting an 8.5″×11″ sheet of paper. In some other embodiments, the pop-up studio may be optimized for shooting a photograph of a document of any size (8.5×11, 8.5×14, 11×17, etc.).

In some embodiments, the pop-up studio may be made of plastic or other materials.

When “popped up,” the pop-up studio can allow a user to place a digital camera device (including a mobile phone camera) on a surface of the box, positioning the camera lens above a printed photograph or document below. When the user inserts a printed photograph or a sheet of paper into the box, the camera and the object may be on parallel planes, thus can avoid distortion. The edges of the printed photograph or sheet of paper may align with the edges of the digital camera device's photograph size capacity or “frame,” thus can avoid the need for cropping later. The box can be turned to face an indirect light source, such as daylight from a northern facing window, thus can avoid reflection.

In certain embodiments, an artificial light source can be attached to the box for working at night or in low light conditions.

In some embodiments, applications may be provided to facilitate photograph effects, photograph storage, photograph organization, scrap-booking, and photograph sharing.

In some embodiments, the pop-up studio may be portable (light-weight, folds and fits in a back pack, hand bag, briefcase, etc.), accessible (e.g., set up in seconds), easy to use (e.g., sized for popular camera phones and typical printed photograph shapes and sizes), and fast (e.g., camera placement facilitates the quick capture and archiving of multiple photographs).

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 illustrates an exemplary front view of the pop-up studio, in accordance with an embodiment of the present invention.

FIG. 2A illustrates an exemplary perspective left front view of the pop-up studio of FIG. 1, in accordance with an embodiment of the present invention.

FIG. 2B illustrates an exemplary perspective top front view of the pop-up studio of FIG. 1, in accordance with an embodiment of the present invention.

FIG. 2C illustrates an exemplary perspective side view of the pop-up studio of FIG. 1, in accordance with an embodiment of the present invention.

FIG. 3 illustrates an exemplary top view of the pop-up studio of FIG. 1, in accordance with an embodiment of the present invention.

FIG. 4 illustrates an exemplary side view of the pop-up studio of FIG. 1, in accordance with an embodiment of the present invention.

FIG. 5 illustrates an exemplary rear view of the pop-up studio of FIG. 1, in accordance with an embodiment of the present invention.

FIGS. 6 and 7 illustrate exemplary operations of the pop-up studio of FIG. 1, in accordance with an embodiment of the present invention.

FIG. 8 illustrates an exemplary view of the pop-up studio of FIG. 1 being folded to a flat position, in accordance with an embodiment of the present invention.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

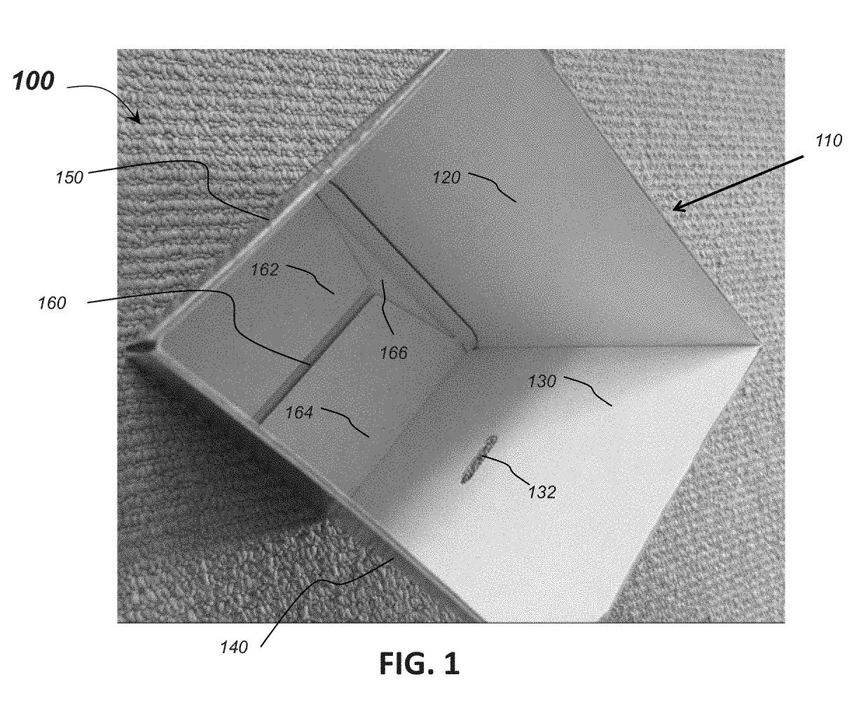

FIGS. 1-8 illustrate exemplary embodiments of a pop-up studio that can capture a high quality photograph of a printed photograph or a document, thereby reducing or eliminating reliance on post-processing or editing to correct framing, lighting and reflection. The pop-up studio can be collapsed flat, can easily fit in a book bag, a brief case, or similar carrier, and can be easy to ship.

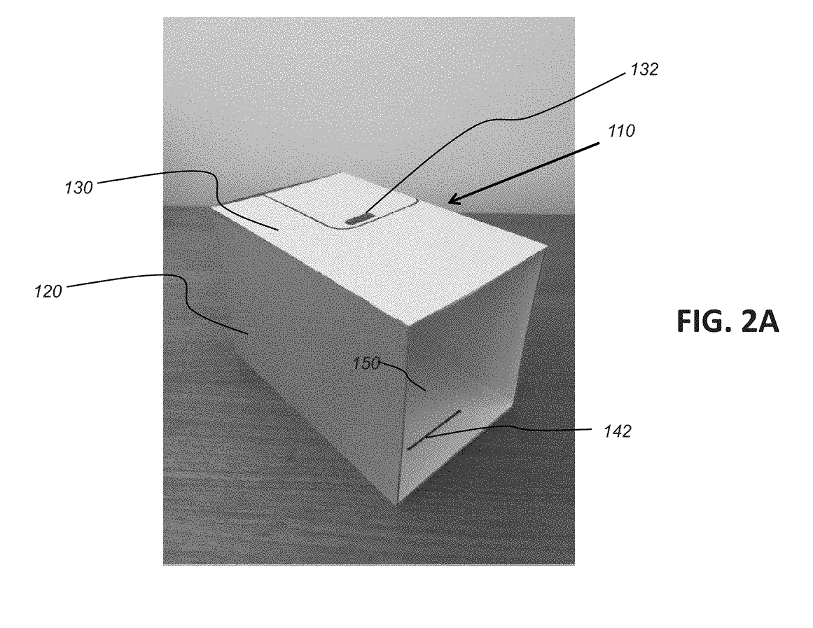

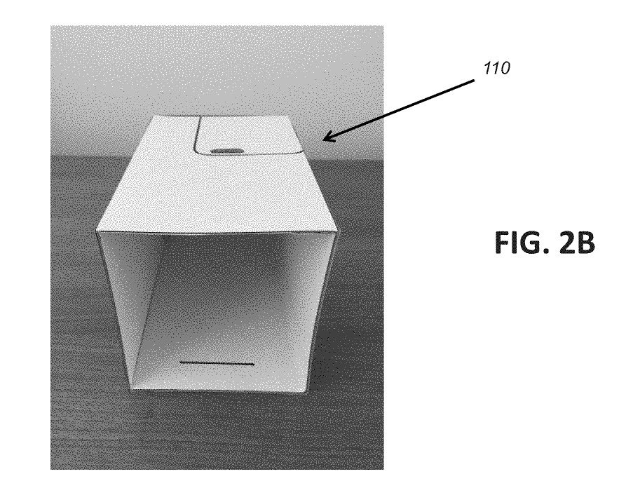

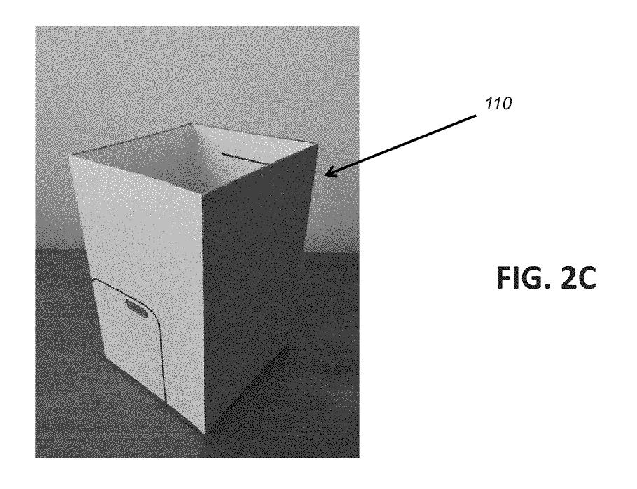

FIG. 1 illustrates an exemplary front view of certain embodiments of a pop-up studio 100, in accordance with an embodiment of the present invention. The pop-up studio 100 may include a box 110 that may be made of cardboard. The box 110 may include four side walls 120, 130, 140 and 150. The back wall 160 may include flaps 162, 164 and 166. The box 110 does not have a front wall. The interior surface of the box 110 may be of flat white color, to limit reflection. The exterior of the box 100 includes an outline (not shown here, see FIGS. 2-4) to guide placement of a digital camera device on a surface of the box in line with a hole 132 for the camera lens. The hole 132 may be of various shapes and sizes.

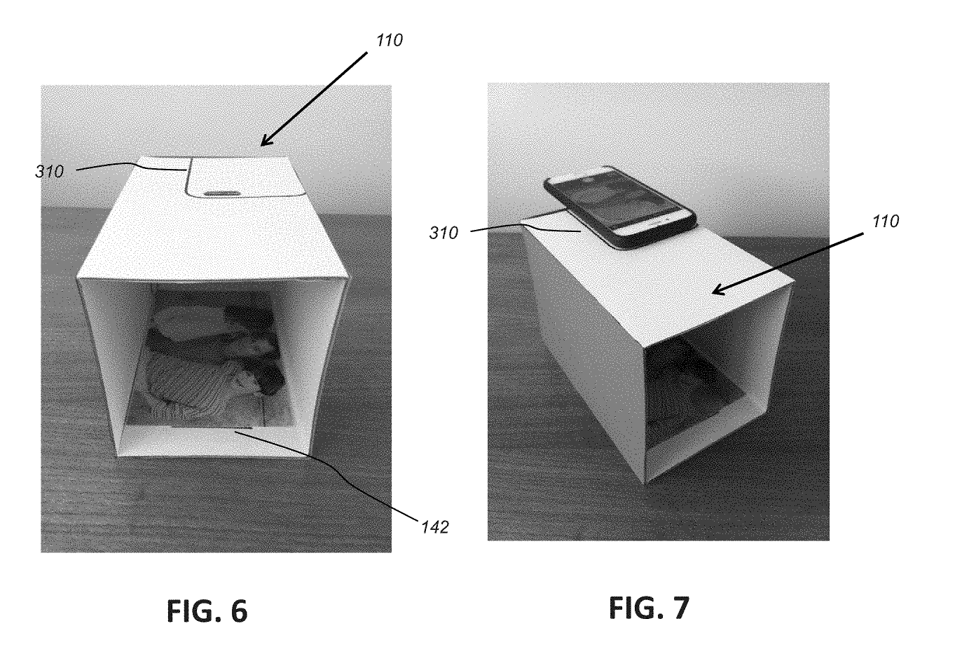

FIG. 2A illustrates an exemplary perspective left front view of the box 110 of the pop-up studio 100, in accordance with an embodiment of the present invention. The (bottom) wall 150 may include a marker 142. In some exemplary operations, the marker 142 may guide a user to place an edge of an object, e.g., a photograph or a document against the marker 142 (see FIGS. 6 and 7).

FIG. 2B illustrates an exemplary perspective top front view of the box 110 of the pop-up studio 100, in accordance with an embodiment of the present invention.

FIG. 2C illustrates an exemplary perspective side view of the box 110 of the pop-up studio 100, showing the box 110 standing up on the back wall 160, in accordance with an embodiment of the present invention.

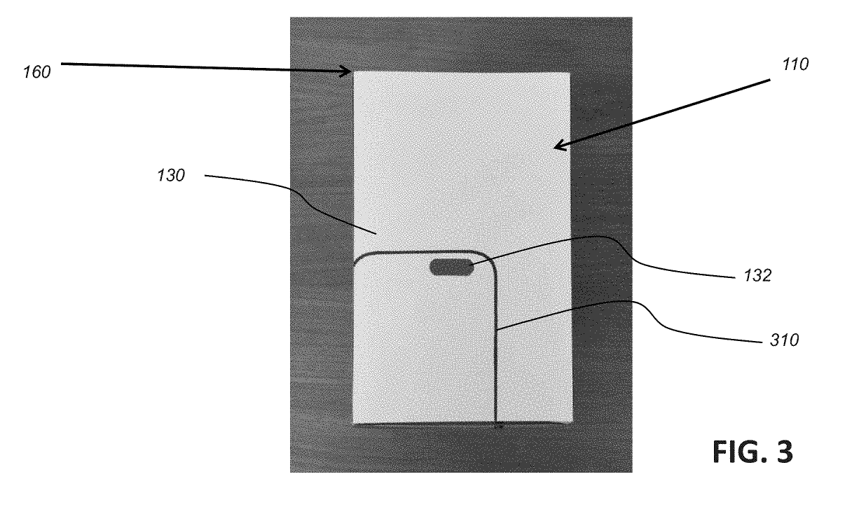

FIG. 3 illustrates an exemplary perspective top view of the box 110 of the pop-up studio 100, in accordance with an embodiment of the present invention. In some embodiments, the (top) wall 130 may include a guide marker 310 to guide a user to place a digital camera device for taking a photograph of the document or printed photograph placed inside the box 110 (see FIGS. 6 and 7).

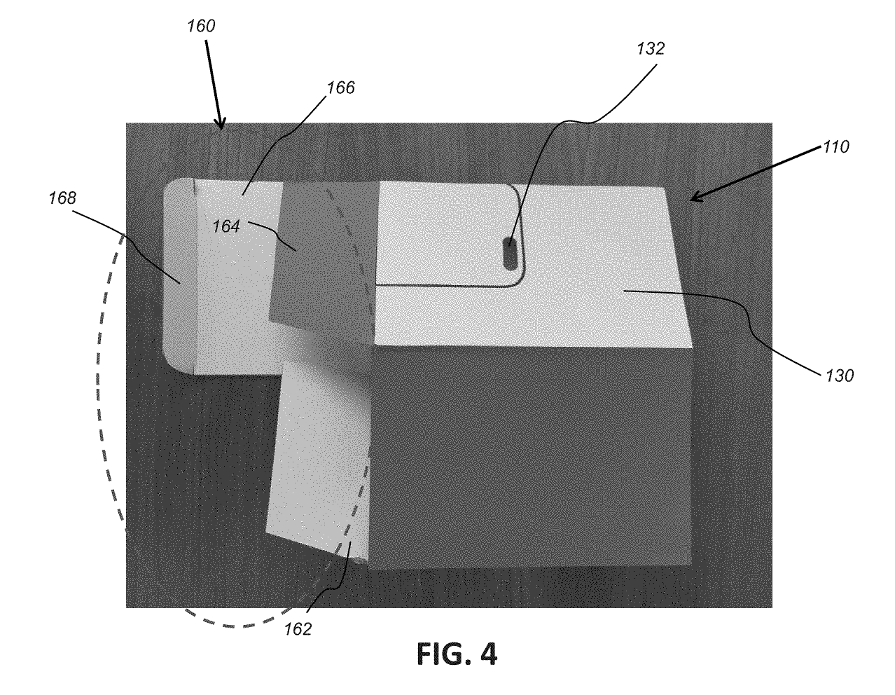

FIG. 4 illustrates an exemplary perspective side view of the box 110 of the pop-up studio 100, in accordance with an embodiment of the present invention. As shown, the back wall 160 may be opened (or closed) using small flaps 162, 164, and large flap 166. Flap 166 may include small flap 168 used to hold flaps 162, 164, 166 in place when the wall 160 is in the closed position.

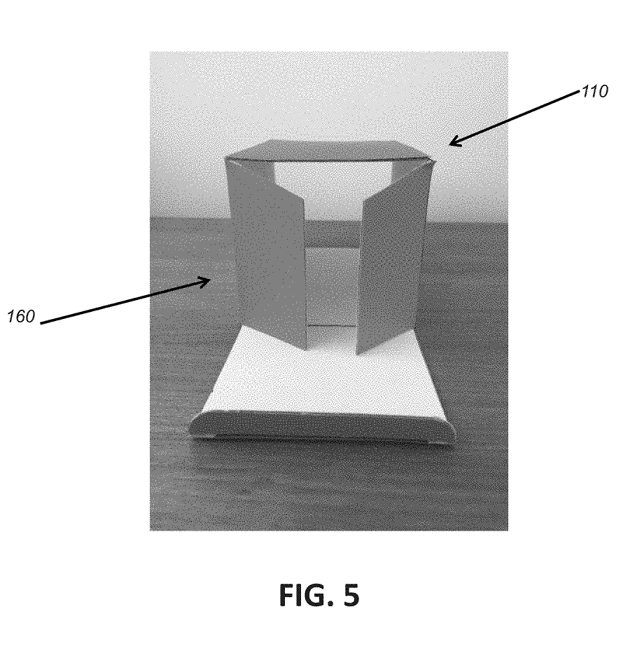

FIG. 5 illustrates an exemplary rear view of the box 110 of the pop-up studio 100, in accordance with an embodiment of the present invention. As shown, the back wall 160 is opened (e.g., during set up, close down, or allowing more light into the inside of the box 110).

FIGS. 6 and 7 illustrate exemplary operations of the pop-up studio 100, in accordance with an embodiment of the present invention. In some exemplary operations, the pop-up studio 100 may advantageously help a user to take a better picture of a printed photograph or document by (1) controlling the position of a digital camera device in relationship to the object, e.g., a printed photograph or document; (2) establishing a fixed distance between the digital camera device lens and the object, e.g., a printed photograph or document; (3) adjusting the lighting on such object; and (4) shielding the body of the camera such that it does not create a reflection (of the camera) in the resulting photograph of the object, e.g., a printed photograph or document.

As shown in FIGS. 6 and 7, a user may place an object, e.g., a printed photograph, inside the box 110, using the marker 142 for guidance. A digital camera device, e.g., a mobile phone with camera, may be placed on the top of the box 110, using the marker 310 for guidance. The camera lens of the digital camera device should be aligned with the hole 132 (not shown as it is covered by the phone), so that it can take a photograph of the object.

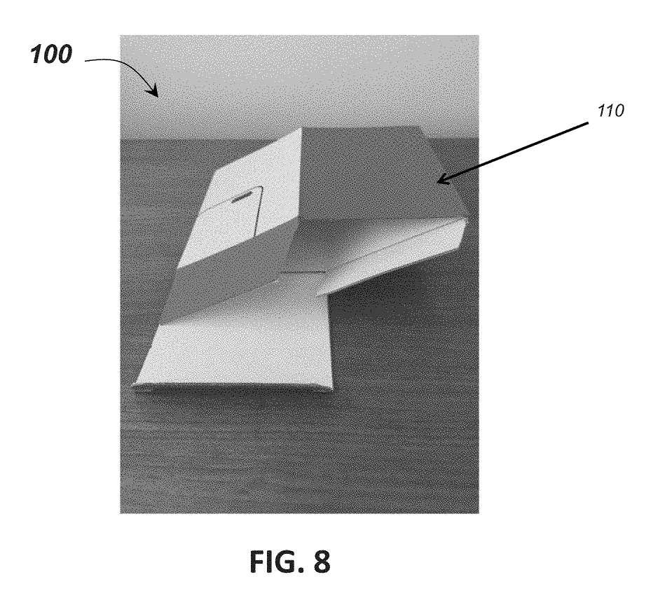

FIG. 8 illustrates an exemplary view of the pop-up studio 100 being folded to a flat position, in accordance with an embodiment of the present invention. In the embodiment shown in FIG. 8, the box of the pop-up studio measures 4 and ¾ inches high by 4 and ¼ inches wide by 7 inches long, as optimized for an iPhone 6 taking a photograph of a 4 inch by 6 inch printed photograph. In other embodiments, the box measurements can vary, as optimized for digital camera devices photographing printed photographs or documents of various sizes.

In some embodiments, one or more applications may be provided to work with the pop-up studio to provide the following functions: photograph effects, photograph storage, photograph organization, scrap-booking, and photograph sharing.

In other embodiments, one or more applications may be provided to work with the pop-up studio to provide the following functions: document assembly (multiple pages), document storage, document organization, document annotation, and document sharing. Other functions are also contemplated.

While embodiments of the present invention have been shown and described, various modifications may be made without departing from the spirit and scope of the present invention, and all such modifications and equivalents are intended to be covered. For example, physical dimensions of the box 110 may be adjusted to accommodate different objects. A box 110 for taking photographs of documents may have larger dimensions than a box 110 for taking photographs of photographs. In another example, different types of back wall 160 flaps may be contemplated.

As used herein and in the appended claims, the singular forms “a”, “an”, and “the” include plural referents unless the context clearly dictates otherwise.

In the following description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art. In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A portable studio, comprising:
a collapsible box having four side walls and a back wall;
a hole for a camera lens positioned in a first wall of one of the four side walls;
the back wall includes one or more flaps for opening and closing the box; and
the box can be collapsed and folded flat.

2. The portable studio of claim 1, wherein the hole positioned in the first wall is sized to receive a camera lens of a camera device placed on the outside surface of the first wall.

3. The portable studio of claim 1, wherein the collapsible box is made of cardboard.

4. The portable studio of claim 1, wherein the collapsible box is made of plastic.

5. The portable studio of claim 1, wherein the collapsible box is collapsed to a flat position.

6. The portable studio of claim 1, wherein the collapsible box is portable.

7. The portable studio of claim 1, wherein an interior surface of each of the four side walls and an interior surface of the back wall are of flat white color.

8. The portable studio of claim 1, wherein the collapsible box further includes a guiding mark or marks positioned on an outside surface of the first wall.

9. The portable studio of claim 2, wherein the camera device is a digital camera.

10. The portable studio of claim 2, wherein the camera device is a mobile phone with a camera.

11. A portable studio, comprising:
a fully assembled box having four side walls and a back wall;
a hole for a camera lens positioned in a first wall of one of the four side walls; and
the back wall includes one or more flaps for opening and closing the box.

12. The portable studio of claim 11, wherein the box is molded.

13. The portable studio of claim 11, wherein the hole positioned in the first wall is sized to receive a camera lens of a camera device placed on the outside surface of the first wall.

14. The portable studio of claim 11, wherein an interior surface of each of the four side walls and an interior surface of the back wall are of flat white color.

15. The portable studio of claim 11, wherein the box further includes a guiding mark or marks positioned on an outside surface of the first wall.

16. The portable studio of claim 13, wherein the camera device is a digital camera.

17. The portable studio of claim 13, wherein the camera device is a mobile phone with a camera.
